(19) United States
(12) Patent Application Publication
(10) Pub. No.: US 2020/0026235 A1
(43) Pub. Date: Jan. 23, 2020

(54) FLOW CHANNEL STRUCTURE AND IMAGE FORMING APPARATUS

(71) Applicant: FUJI XEROX CO., LTD., TOKYO (JP)

(72) Inventors: Tetsuya KAWATANI, Kanagawa (JP); Kokichi KASAI, Kanagawa (JP); Kazunari ISHII, Kanagawa (JP); Yuka NOMURA, Kanagawa (JP)

(73) Assignee: FUJI XEROX CO., LTD., TOKYO (JP)

(21) Appl. No.: 16/256,995

(22) Filed: Jan. 24, 2019

(30) Foreign Application Priority Data
Jul. 19, 2018 (JP) 2018-135958

(51) Int. Cl. G03G 21/20; G03G 15/20

(52) U.S. Cl. CPC G03G 21/206; G03G 2221/1645; G03G 15/2064; G03G 15/2053

(57) ABSTRACT

A flow channel structure includes a duct that includes a flow channel through which air is blown and sucks air around a fixation device that fixes a toner image on a recording medium by using an air blowing unit; and an electrically conductive contact surface that is provided in the duct and is disposed so as to cross an air blowing direction in the duct.

### CROSS-REFERENCE TO RELATED APPLICATIONS

This application is based on and claims priority under 35 USC 119 from Japanese Patent Application No. 2018-135958 filed Jul. 19, 2018.

### BACKGROUND

### (i) Technical Field

The present disclosure relates to a flow channel structure and an image forming apparatus.

### (ii) Related Art

Japanese Unexamined Patent Application Publication No. 2016-085407 discloses an image forming apparatus that has a filter in an exhaust air duct and prolongs lifetime of the filter by changing an air flow so that air passes through the filter only in a case where a lot of ultra fine particles are generated.

Japanese Unexamined Patent Application Publication No. 2017-003770 discloses an image forming apparatus that discharges exhaust air for fixation together with a sheet of paper while circulating the exhaust air for fixation in the apparatus.

Japanese Unexamined Patent Application Publication No. 2015-214164 discloses an image forming apparatus that creates a swirling flow so as to increase filtration efficiency by providing a partition plate and a heating device in a duct and thereby prolongs lifetime.

### SUMMARY

Aspects of non-limiting embodiments of the present disclosure relate to a flow channel structure and an image forming apparatus that reduce an amount of discharged ultra fine particles (UFPs) as compared with a configuration in which air flows along a wall surface of a duct.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a flow channel structure including a duct that includes a flow channel through which air is blown and sucks air around a fixation device that fixes a toner image on a recording medium by using an air blowing unit; and an electrically conductive contact surface that is provided in the duct and is disposed so as to cross an air blowing direction in the duct.

### BRIEF DESCRIPTION OF THE DRAWINGS

Exemplary embodiments of the present disclosure will be described in detail based on the following figures, wherein:

FIG. 1 illustrates a configuration of an image forming apparatus to which a flow channel structure according to the first exemplary embodiment is applied;

FIG. 2 is a perspective view illustrating a duct used in the flow channel structure according to the first exemplary embodiment and a fixation device in which the duct is disposed;

FIG. 3 is a lateral cross-sectional view illustrating a state where the duct used in the flow channel structure according to the first exemplary embodiment is disposed on an inlet side of the fixation device in a paper transport direction;

FIG. 4 is a cross-sectional view schematically illustrating a duct used in the flow channel structure according to the first exemplary embodiment and a fixation device in which the duct is disposed;

FIG. 5 is a cross-sectional view illustrating a duct used in a flow channel structure according to the second exemplary embodiment;

FIG. 6 is a cross-sectional view illustrating a duct used in a flow channel structure according to the third exemplary embodiment;

FIG. 7 is a cross-sectional view illustrating a duct used in a flow channel structure according to the fourth exemplary embodiment;

FIG. 8 is a cross-sectional view illustrating a duct used in a flow channel structure according to the fifth exemplary embodiment;

FIG. 9 schematically illustrates a flow speed of air flowing in the duct used in the flow channel structure according to the fifth exemplary embodiment;

FIG. 10 is a cross-sectional view illustrating a duct used in a flow channel structure according to the sixth exemplary embodiment;

FIG. 11 is a cross-sectional view illustrating a duct used in a flow channel structure according to the seventh exemplary embodiment;

FIG. 12 is a cross-sectional view illustrating a duct used in a flow channel structure according to the eighth exemplary embodiment;

FIG. 13 is a cross-sectional view illustrating a duct used in a flow channel structure according to the ninth exemplary embodiment;

FIG. 14 is a cross-sectional view illustrating a duct used in a flow channel structure according to the tenth exemplary embodiment;

FIG. 15 is a cross-sectional view illustrating a duct used in a flow channel structure according to the eleventh exemplary embodiment;

FIG. 16A is a cross-sectional view illustrating a case where an upstream-side angle of a sheet metal in a duct is 135°, FIG. 16B is a cross-sectional view illustrating a case where an upstream-side angle of a sheet metal in a duct is 90°, and FIG. 16C is a cross-sectional view illustrating a case where an upstream-side angle of a sheet metal in a duct is 45°;

FIG. 17 is a graph illustrating a relationship between an angle of a sheet metal in a duct and a rate of collection of ultra fine particles; and

FIG. 18A is a lateral cross-sectional view illustrating an example in which a duct used in a flow channel structure is disposed on an outlet side of a fixation device in a paper transport direction, FIG. 18B is a lateral cross-sectional view illustrating an example in which a duct used in a flow channel structure is disposed beside a central part of a fixation device in a paper transport direction, and FIG. 18C is a lateral cross-sectional view illustrating an example in which a duct used in a flow channel structure is disposed so as to cover a whole fixation device in a paper transport direction.

### DETAILED DESCRIPTION

Exemplary embodiments of the present disclosure are described below with reference to the drawings. It is assumed that a direction indicated by arrow H in the drawings is an apparatus height direction (vertical direction) and a direction indicated by arrow W in the drawings is an apparatus width direction (horizontal direction). Furthermore, it is assumed that a direction indicated by arrow D, i.e., a direction orthogonal to the apparatus height direction and the apparatus width direction is an apparatus depth direction (horizontal direction).

### First Exemplary Embodiment

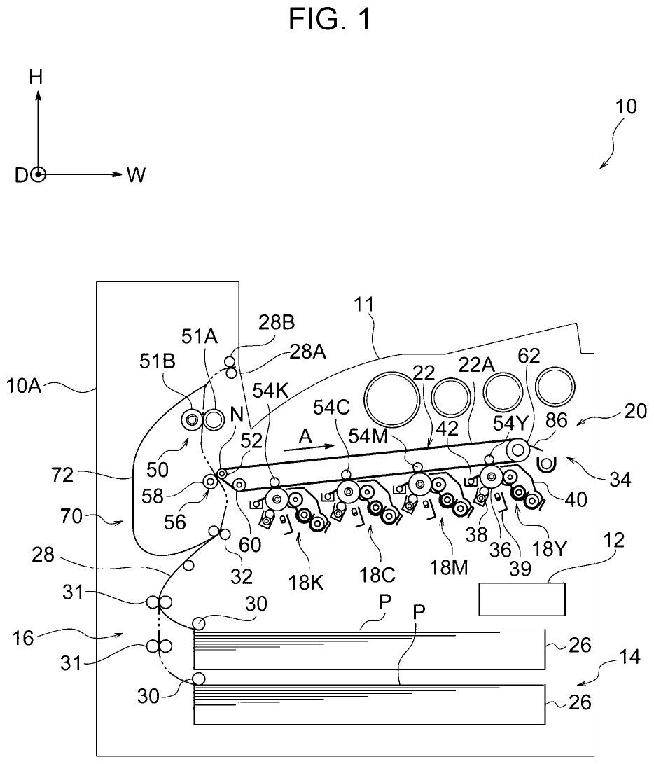

An example of an image forming apparatus according to a first exemplary embodiment of the present disclosure is described with reference to FIGS. 1 through 4. Hereinafter, yellow, magenta, cyan, and black are referred to as Y, M, C, and K, and color signs (Y, M, C, and K) corresponding to the respective colors are given to ends of signs given to constituent elements and toner images (images) that need be distinguished from one another on the basis of colors. In a case where the constituent elements and toner images are collectively referred to without being distinguished from one another on the basis of colors, the color signs at the ends of the signs given to the constituent elements and toner images are omitted.

### Overall Configuration of Image Forming Apparatus

FIG. 1 illustrates an example of a configuration of an image forming apparatus according to the present exemplary embodiment. As illustrated in FIG. 1, an image forming apparatus 10 includes a storage part 14 in which a sheet of paper P that is an example of a recording medium is stored and a transport device 16 that transports the sheet of paper P stored in the storage part 14. Furthermore, the image forming apparatus 10 includes an image forming part 20 that forms an image on the sheet of paper P transported from the storage part 14 by the transport device 16 and a controller 12 that controls each part. A document reading part (not illustrated) that reads a document is provided on an upper side of an apparatus body 10A of the image forming apparatus 10.

The storage part 14 includes two storage members 26 that are drawable from the apparatus body 10A of the image forming apparatus 10 toward a near side in the apparatus depth direction, and, for example, two kinds (sizes) of sheets of paper P are stacked in the respective storage members 26. Furthermore, each of the storage members 26 includes a feeding roller 30 that feeds the sheets of paper P stacked on the storage member 26 to a transport path 28 provided in the transport device 16.

The transport device 16 includes a plurality of pairs of transport rollers 31 that transport a sheet of paper P along the transport path 28 for transporting the sheet of paper P and a pair of position adjustment rollers 32 that adjusts a transport timing of the sheet of paper P.

The image forming part 20 includes four image forming units 18Y, 18M, 18C, and 18K for respective colors of yellow (Y), magenta (M), cyan (C), and black (K). The image forming units 18 of the respective colors are attachable to and detachable from the apparatus body 10A. The image forming units 18 of the respective colors each include a photoconductor drum 36 that rotates in a counterclockwise direction in FIG. 1 and a charging member 38 that charges a surface of the photoconductor drum 36. Furthermore, each of the image forming units 18 includes an exposure device 39 that radiates exposure light to the charged photoconductor drum 36 and a developing device 40 that develops an electrostatic latent image formed by radiation of the exposure light by using a developer and thereby visualizes the electrostatic latent image as a toner image.

Furthermore, each of the image forming units 18 includes a cleaning device 42 that scrapes a foreign substance on the photoconductor drum 36 from the photoconductor drum 36.

Furthermore, the image forming part 20 includes an endless transfer belt 22 that is suspended around an auxiliary roller 52 and a plurality of rollers 60 and 62 that will be described later and circulates in a direction indicated by arrow A in FIG. 1. Furthermore, the image forming part 20 includes first transfer rollers 54Y, 54M, 54C, and 54K that are disposed on an inner side of the transfer belt 22 and transfer toner images formed by the image forming units 18 of the respective colors onto a surface 22A of the transfer belt 22. The transfer belt 22 is an example of an image carrier. Furthermore, the image forming part 20 includes a cleaning device 34 that scrapes a foreign substance such as remaining toner on the transfer belt 22 from the transfer belt 22 by using a blade 35.

Furthermore, the image forming part 20 includes a second transfer part 56 that is an example of a transfer part that transfers, onto the sheet of paper P, the toner images transferred onto the surface 22A of the transfer belt 22. The second transfer part 56 includes a second transfer roller 58 disposed on a front surface side of the transfer belt 22 and the auxiliary roller 52 around which the transfer belt 22 is wound on a side of the transfer belt 22 opposite to the second transfer roller 58. The auxiliary roller 52 is driven by the circulating transfer belt 22 to rotate. In the present exemplary embodiment, the second transfer roller 58 is connected to the ground, the auxiliary roller 52 constitutes a counter electrode of the second transfer roller 58, and the auxiliary roller 52 transfers a toner image onto a sheet of paper P upon application of a second transfer voltage.

The apparatus body 10A includes, on a downstream side of the second transfer part 56 in a transport direction in which the sheet of paper P is transported, a fixation device 50 that fixes a toner image onto a sheet of paper P by heating and pressing the sheet of paper P onto which the toner image has been transferred. The fixation device 50 includes a heating rotating body 51A that heats the toner image on a surface of the sheet of paper P and a pressing rotating body 51B that presses the sheet of paper P against the heating rotating body 51A from a back surface side of the sheet of paper P.

The transport device 16 of the apparatus body 10A includes, on a downstream side of the fixation device 50 in the transport direction in which the sheet of paper P is transported, a pair of discharge rollers 28A and 28B that discharge the sheet of paper P to a discharge part 11 provided in an upper part of the apparatus body 10A.

Furthermore, the transport device 16 includes, beside the image forming part 20, a reversing transport part 70 used to form an image on both surfaces of the sheet of paper P. The reversing transport part 70 has a function of reversing the sheet of paper P having an image fixed on a front surface (one surface) thereof in order to form a toner image on a back surface (the other surface) of the sheet of paper P without discharging the sheet of paper P to the discharge part 11 as it is by using the discharge rollers 28A and 28B. The reversing transport part 70 includes a reversing path 72 along which the sheet of paper P is transported from the discharge rollers 28A and 28B toward the position adjustment rollers 32 so as to be reversed and a plurality of pairs of rollers (not illustrated) that transport the sheet of paper P along the reversing path 72.

### Operation of Image Forming Apparatus

The image forming apparatus 10 forms an image as follows.

First, the charging members 38 for the respective colors to which a voltage has been applied uniformly negatively charge the surfaces of the photoconductor drums 36 for the respective colors at a predetermined potential. Then, the exposure devices 39 form electrostatic latent images by irradiating the charged surfaces of the photoconductor drums 36 for the respective colors with exposure light on the basis of image data read by the document reading part (not illustrated). This forms electrostatic latent images corresponding to the data on the surfaces of the photoconductor drums 36 for the respective colors. Furthermore, the developing devices 40 for the respective colors visualize the electrostatic latent images as toner images by developing the electrostatic latent images. The toner images formed on the surfaces of the photoconductor drums 36 for the respective colors are sequentially transferred onto the transfer belt 22 by the first transfer rollers 54. In this way, the toner images are held on the surface 22A of the transfer belt 22.

A sheet of paper P fed from the storage member 26 to the transport path 28 by the feeding roller 30 is fed to a transfer nip part N where the transfer belt 22 and the second transfer roller 58 are in contact with each other. In the transfer nip part N, the sheet of paper P is transferred between the transfer belt 22 and the second transfer roller 58, and thus the toner images on the surface 22A of the transfer belt 22 are transferred onto a surface of the sheet of paper P.

The toner images transferred onto the surface of the sheet of paper P are fixed on the sheet of paper P by the fixation device 50. Then, the sheet of paper P on which the toner images have been fixed is discharged to the discharge part 11 outside the apparatus body 10A by rotation of the discharge rollers 28A and 28B.

Meanwhile, in a case where an image is formed on both surfaces of the sheet of paper P, the sheet of paper P is transported to the reversing path 72 by reversing rotation of the discharge rollers 28A and 28B in a state where a rear end of the sheet of paper P is nipped. Then, the sheet of paper P is transported to the second transfer part 56 at a predetermined timing by rotation of the position adjustment roller 32, and the toner images are transferred from the transfer belt 22 onto a back surface of the sheet of paper P. The toner images transferred onto the back surface of the sheet of paper P are fixed on the sheet of paper P by the fixation device 50. Then, the sheet of paper P on which the toner images have been fixed is discharged to the discharge part 11 outside the apparatus body 10A by rotation of the discharge rollers 28A and 28B. In this way, an image is formed on both surfaces of the sheet of paper P.

### Configuration of Substantial Part

Next, the fixation device 50 that is a substantial part of the image forming apparatus 10 and a flow channel structure 100 according to the first exemplary embodiment are described.

### Fixation Device 50

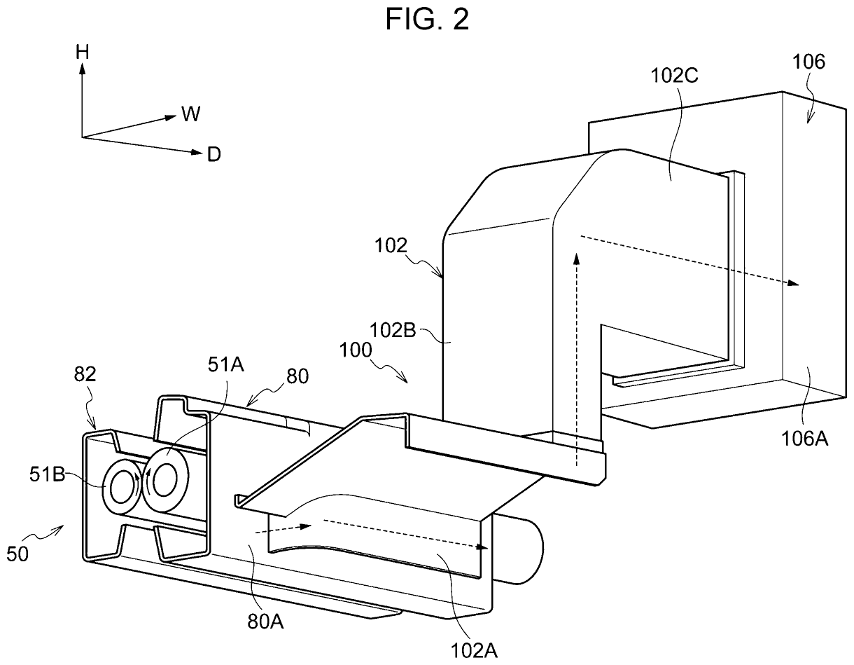

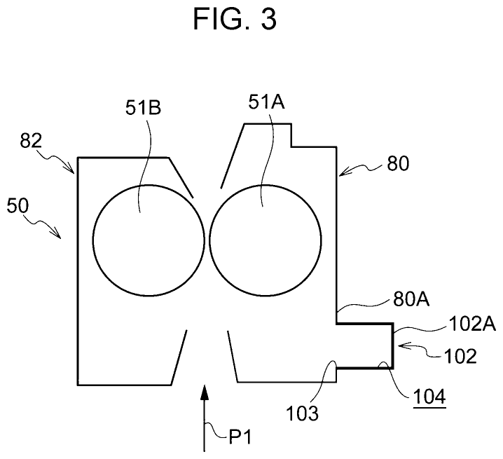

As illustrated in FIGS. 2 and 3, the fixation device 50 includes the heating rotating body 51A that is disposed along the apparatus depth direction and the pressing rotating body 51B that is in contact with the heating rotating body 51A and is disposed along the apparatus depth direction. Furthermore, the fixation device 50 includes a housing 80 that covers the heating rotating body 51A excluding a side thereof that is in contact with the pressing rotating body 51B and a housing 82 that covers the pressing rotating body 51B excluding a side thereof that is in contact with the heating rotating body 51A. For easy understanding of the configuration of the fixation device 50, FIG. 3 schematically illustrates a cross section of the fixation device 50.

The housing 80 is disposed so as to surround an upstream side (a lower side in the present exemplary embodiment) of the heating rotating body 51A in the transport direction (a direction indicated by arrow P1 in FIG. 3) in which the sheet of paper P is transported, a side (a back side of the heating rotating body 51A) opposite to a part of the heating rotating body 51A that is in contact with the pressing rotating body 51B, and a downstream side (an upper side in the present exemplary embodiment) of the heating rotating body 51A in the transport direction in which the sheet of paper P is transported. The housing 82 is disposed so as to surround an upstream side (a lower side in the present exemplary embodiment) of the pressing rotating body 51B in the transport direction in which the sheet of paper P is transported, a side (a back side of the pressing rotating body 51B) opposite to a part of the pressing rotating body 51B that is in contact with the heating rotating body 51A, and a downstream side (an upper side in the present exemplary embodiment) of the pressing rotating body 51B in the transport direction in which the sheet of paper P is transported.

### Flow Channel Structure 100

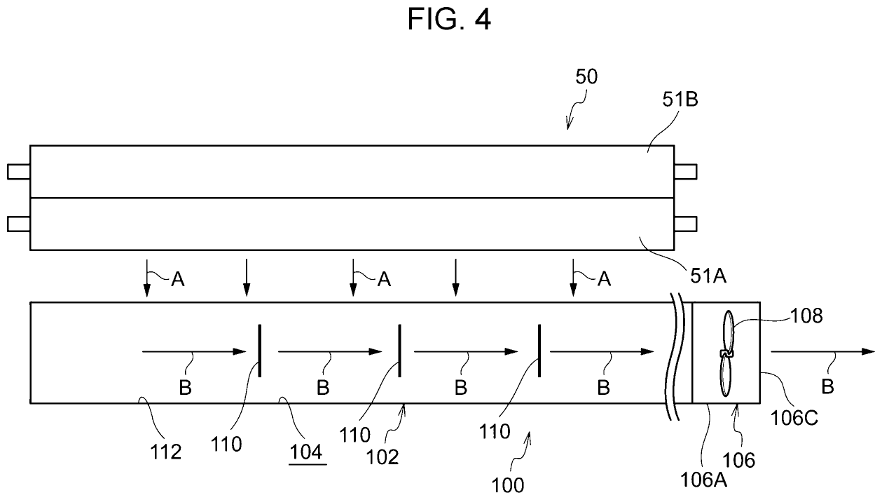

The flow channel structure 100 includes a duct 102 that sucks air around the fixation device 50 by using a fan 108 (see FIG. 4) that will be described later. In the present exemplary embodiment, the duct 102 is connected to a lower part 80A of the housing 80 on an upstream side of the heating rotating body 51A in the transport direction in which the sheet of paper P is transported. A flow channel 104 (see FIG. 4) through which air is blown is provided in the duct 102.

As illustrated in FIG. 2, the duct 102 includes a first duct part 102A that is connected to the lower part 80A of the housing 80 and is disposed toward a far side in the apparatus depth direction and a second duct part 102B that is disposed from a downstream-side end of the first duct part 102A toward an upper side in the apparatus up-down direction. An inlet 103 (see FIG. 3) through which air is introduced into the first duct part 102A is connected to the lower part 80A of the housing 80. Furthermore, the duct 102 includes a third duct part 102C that is disposed from an upper end of the second duct part 102A toward a far side in the apparatus depth direction. An air blower device 106 that is an example of an air blowing unit is provided at a downstream-side end of the third duct part 102C.

The air blower device 106 includes a substantially rectangular tubular body 106A. The fan 108 is disposed in the tubular body 106A (see FIG. 4). An axial direction of a rotary axis of the fan 108 is disposed along a longitudinal direction of the third duct part 102C. This allows air to be blown through the flow channel 104 in the duct 102 by rotation of the fan 108. An outlet 106C through which air in the duct 102 is discharged is provided at an end of the tubular body 106A (see FIG. 4). The outlet 106C is provided in an outer wall of the image forming apparatus 10. The first duct part 102A, the second duct part 102B, the third duct part 102C, and the tubular body 106A are an example of a wall connecting the inlet 103 and the outlet 106C of the duct 102. The inlet 103 of the duct 102 is provided at a position including an upstream side (i.e., an inlet side of the fixation device 50) in the housing 80 of the fixation device 50 in the transport direction (the direction indicated by arrow P1) in which the sheet of paper P is transported (see FIGS. 2 and 3). The “upstream side of the fixation device in the transport direction in which the sheet of paper P is transported” refers to an upstream side relative to a part where the heating rotating body 51A and the pressing rotating body 51B provided in the fixation device 50 face each other.

As illustrated in FIG. 4, an electrically conductive contact plate 110 disposed so as to cross an air blowing direction (a direction indicated by arrow B) in the duct 102 is provided in the duct 102. A plurality of (three in the present exemplary embodiment) contact plates 110 are provided in the duct 102. In the present exemplary embodiment, the plurality of contact plates 110 have the same size. Surfaces of the contact plates 110 that face an upstream side are an example of a contact surface. The expression “electrically conductive” refers to a state where the electric potentials of the contact plates 110 fall to the earth and as a result, surface potentials of the contact plates 110 become less than 10. A surface potential meter MODEL344 manufactured by Trek Japan K.K. is used as a surface potential meter. The contact plates 110 may be connected to the ground or may be configured not to be connected to the ground. For easy understanding of the configuration of the flow channel structure 100, FIG. 4 schematically illustrates a cross section of the flow channel structure 100 in which a plate thickness and the housing 80 are omitted and the duct 102 is developed to be straight.

The plurality of contact plates 110 are provided in a central part of the duct 102 in the width direction so that both ends of the contact plates 110 in the width direction are spaced away from an inner wall surface 112 of the duct 102. This allows air to flow between the contact plates 110 and the inner wall surface 112 of the duct 102. In the present exemplary embodiment, the contact plates 110 are made of a metal such as aluminum, copper, brass, or stainless steel (SUS). The contact plates 110 may be made of electrically conductive plastic instead of a metal. An example of the electrically conductive plastic is one given increased electric conductivity by increasing an amount of carbon black or the like in a resin. Only upstream-side surfaces of the contact plates 110 in the air blowing direction in the duct 102 may be given electric conductivity.

In the flow channel structure 100, air is blown in a direction indicated by arrows B through the flow channel 104 in the duct 102 due to rotation of the fan 108. The contact plates 110 are disposed in a central part of the substantially rectangular flow channel 104 so as to cross the air blowing direction (the direction indicated by arrows B, i.e., a longitudinal direction of the duct 102 in plan view). In the present exemplary embodiment, the contact plates 110 are disposed so as to be orthogonal to the air blowing direction (the direction indicated by arrows B). The contact plates 110 are supported by a part of the inner wall surface 112 of the duct 102.

For example, the inner wall surface 112 of the duct 102 is made of an electrically conductive material. In the present exemplary embodiment, for example, a metal foil such as aluminum is attached to the wall surface 112 of the duct 102.

### Operation and Effects

Next, operation and effects of the present exemplary embodiment are described.

As illustrated in FIG. 4, in the flow channel structure 100, air around the fixation device 50 is sucked toward the duct 102 as indicated arrow A due to rotation of the fan 108. Then, air introduced from the inlet 103 (see FIG. 3) of the duct 102 into the duct 102 is blown in the direction indicated by arrows B through the flow channel 104 in the duct 102. Then, air is discharged from the outlet 106C of the duct 102 to an outside of the image forming apparatus 10.

A flow channel structure (not illustrated) of an image forming apparatus according to a comparative example is described below. In the flow channel structure of the image forming apparatus according to the comparative example, a fan equipped with a filter is provided on a downstream side of a flow channel of a duct. In recent years, growing awareness of the environment and safety has led to stricter regulation in each country on an environment level of substances emitted from an image forming apparatus, especially ultra fine particles (UFPs) having a particle size of 100 nm or less. In the image forming apparatus according to the comparative example, air discharged to an outside of the image forming apparatus is purified by causing a filter provided in the duct to collect ultra fine particles.

However, the flow channel structure of the image forming apparatus according to the comparative example, in which the filter is provided, cost is high. Furthermore, air is harder to flow from the image forming apparatus due to influence of a pressure loss. This leads to a risk of an increase in temperature in the image forming apparatus. In a case where performance of the fan is increased in order to keep a flow amount, it is feared that noise and an increase in electric power consumption occur.

Meanwhile, in the flow channel structure 100 of the image forming apparatus 10 according to the present exemplary embodiment, the plurality of electrically conductive contact plates 110 are provided in the duct 102. The plurality of electrically conductive contact plates 110 are disposed so as to cross the air blowing direction (the direction indicated by arrows B) in the duct 102. This causes air blown in the duct 102 to make contact with the plurality of contact plates 110, thereby causing ultra fine particles (UFPs) to adhere to the plurality of contact plates 110. It has been experimentally confirmed that ultra fine particles are easier to adhere to the electrically conductive contact plates 110 than to non-conductive contact plates. Accordingly, an amount of ultra fine particles (UFPs) contained in air decreases on a downstream side of the plurality of contact plates 110 in the air blowing direction of the duct 102.

In the flow channel structure 100, an amount of discharged ultra fine particles (UFPs), i.e., an amount of ultra fine particles (UFPs) discharged from the outlet 106C of the duct 102 to an outside of the image forming apparatus 10 is reduced as compared with a configuration in which air flows along a wall surface of a duct.

In the image forming apparatus 10, an amount of ultra fine particles is reduced without using a filter. This makes it possible to construct a system of a lower pressure loss than a filter. Accordingly, it is unnecessary to increase performance of the fan 108, and it is possible to reduce influence on noise and electric power. Furthermore, in a case where a filter is used, cost for replacement is needed in addition to initial cost because the filter has a lifetime. Meanwhile, in the image forming apparatus 10, cost for replacement is not needed. It is therefore possible to provide a less expensive system than a case where a filter is used.

In the flow channel structure 100, the inlet 103 of the duct 102 is provided at a position including an upstream side of the fixation device 50 in the transport direction in which the sheet of paper P is transported. Accordingly, in the image forming apparatus 10, ultra fine particles are easier to flow into the duct 102 than a configuration in which an inlet of a duct is provided on a downstream side of a fixation device in a transport direction in which a sheet of paper P is transported.

In the flow channel structure 100, the inner wall surface 112 of the duct 102 is made of an electrically conductive material. Accordingly, in the flow channel structure 100, ultra fine particles are easier to adhere to or aggregate on the inner wall surface 112 of the duct 102 than a configuration in which an inner wall surface of a duct is an insulating material. This reduces an amount of ultra fine particles discharged to an outside of the image forming apparatus 10.

### Second Exemplary Embodiment

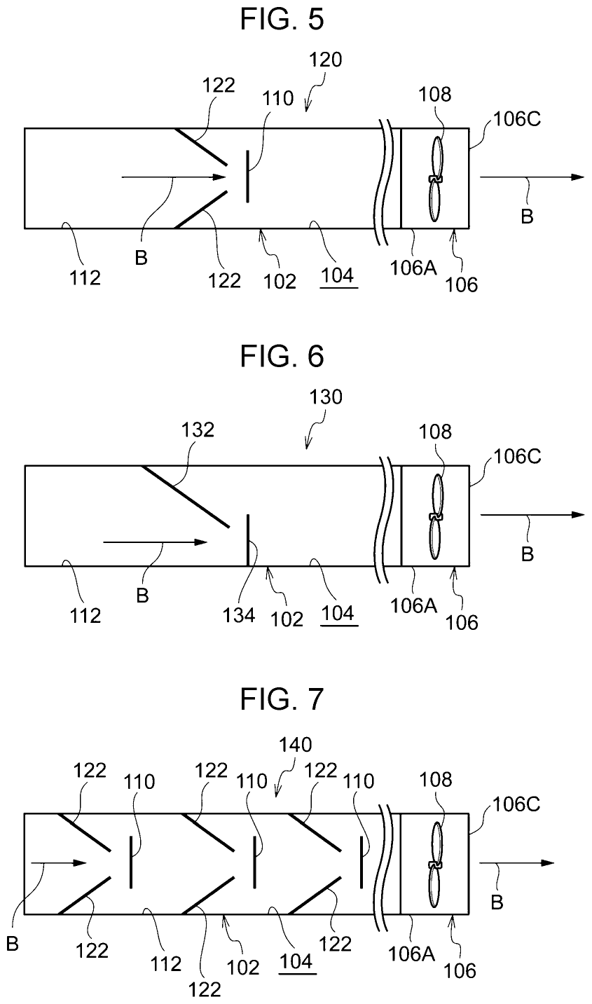

Next, a flow channel structure according to the second exemplary embodiment is described with reference to FIG. 5. Constituent elements identical to those in the first exemplary embodiment are given identical reference signs, and description thereof is omitted.

As illustrated in FIG. 5, narrowing parts 122 that narrow a flow channel 104 of a duct 102 are provided in a flow channel structure 120. Furthermore, in the flow channel structure 120, a contact plate 110 is provided so as to be hit by air narrowed by the narrowing parts 122.

The narrowing parts 122 are a pair of electrically conductive plates that are supported at opposing positions of an inner wall surface 112 of the duct 102 and protrude in the flow channel 104. The narrowing parts 122 are, for example, made of a metal. An interval for passage of air is set between the pair of narrowing parts 122. A downstream-side angle of each of the narrowing parts 122 relative to the inner wall surface 112 (an angle on a downstream side in an air blowing direction in the flow channel 104) is preferably not more than 90° and not less than 10°, more preferably not more than 80° and not less than 20°, further more preferably not more than 70° and not less than 30°.

For example, the interval between the pair of narrowing parts 122 is smaller than the size of the contact plate 110. Furthermore, the interval between the pair of narrowing parts 122 is larger than an opening of the filter of the comparative example. Accordingly, the interval between the pair of narrowing parts 122 is set to a size such that no clogging occurs and there is no influence on a pressure loss unlike the filter of the comparative example.

The contact plate 110 is disposed on a downstream side of the pair of narrowing parts 122 in the air blowing direction (the direction indicated by arrows B) so as to face the interval between the pair of narrowing parts 122. In the present exemplary embodiment, the contact plate 110 is hit by air whose flow speed is increased toward a downstream side in the air blowing direction by narrowing the flow channel by using the pair of narrowing parts 122.

The flow channel structure 120 has the following effects in addition to the effects produced by the configuration similar to the flow channel structure 100 according to the first exemplary embodiment. In the flow channel structure 120, ultra fine particles are easier to adhere to or aggregate on the contact plates 110 than in a configuration in which a flow channel is not narrowed. This reduces an amount of ultra fine particles discharged to an outside of the image forming apparatus 10.

In the flow channel structure 120, ultra fine particles are easier to adhere to or aggregate on the contact plate 110 than in a configuration in which a flow speed is uniform in an air blowing direction in a flow channel. This reduces an amount of ultra fine particles discharged to an outside of the image forming apparatus 10.

In the present exemplary embodiment, the narrowing parts 122 are made of an electrically conductive material but may be made of a material other than an electrically conductive material.

### Third Exemplary Embodiment

Next, a flow channel structure according to the third exemplary embodiment is described with reference to FIG. 6. Constituent elements identical to those in the first and second exemplary embodiments are given identical reference signs, and description thereof is omitted.

As illustrated in FIG. 6, a flow channel structure 130 includes a narrowing part 132 that narrows a flow channel 104 of a duct 102 and an electrically conductive contact plate 134 that is an example of a contact surface disposed so as to be hit by air narrowed by the narrowing part 132.

The narrowing part 132 is an electrically conductive plate that is supported by an inner wall surface 112 of the duct 102 and protrudes in the flow channel 104. The narrowing part 132 is, for example, made of a metal. An interval for passage of air is set between a front end of the narrowing part 132 and the inner wall surface 112 of the duct 102.

The interval between the front end of the narrowing part 132 and the inner wall surface 112 of the duct 102 is smaller than the size of the contact plate 134.

The contact plate 134 is disposed on a downstream side of the narrowing part 132 in an air blowing direction (a direction indicated by arrow B) so as to face the interval between the front end of the narrowing part 132 and the inner wall surface 112 of the duct 102. The contact plate 134 is, for example, made of a metal.

In the flow channel structure 130, similar effects can be obtained by the configuration similar to the flow channel structure 120 according to the second exemplary embodiment.

In the present exemplary embodiment, the narrowing part 132 is made of an electrically conductive material but may be made of a material other than an electrically conductive material.

### Fourth Exemplary Embodiment

Next, a flow channel structure according to the fourth exemplary embodiment is described with reference to FIG. 7. Constituent elements identical to those in the first through third exemplary embodiments are given identical reference signs, and description thereof is omitted.

As illustrated in FIG. 7, in a flow channel structure 140, a plurality of (three in the present exemplary embodiment) pairs of narrowing parts 122 that narrow a flow channel 104 of a duct 102 and a plurality of (three in the present exemplary embodiment) contact plate 110 disposed so as to be hit by air narrowed by the narrowing parts 122 are provided along an air blowing direction (a direction indicated by arrows B).

In the present exemplary embodiment, the contact plates 110 are hit by air whose flow speed is increased toward a downstream side in the air blowing direction (the direction indicated by arrows B) by narrowing the flow channel by using the plurality of pairs of narrowing parts 122.

In the flow channel structure 140, the following effects can be obtained in addition to the effects produced by the configuration similar to the flow channel structure 120 according to the second exemplary embodiment. In the flow channel structure 140, ultra fine particles are easier to adhere to or aggregate on the contact plates 110 than in a configuration in which a flow speed is uniform in an air blowing direction in a flow channel. This reduces an amount of ultra fine particles discharged to an outside of the image forming apparatus 10.

In the flow channel structure 140, ultra fine particles are easier to adhere to or aggregate on the contact plates 110 than in a configuration in which a single narrowing part and a single contact surface are provided. This reduces an amount of ultra fine particles discharged to an outside of the image forming apparatus 10.

### Fifth Exemplary Embodiment

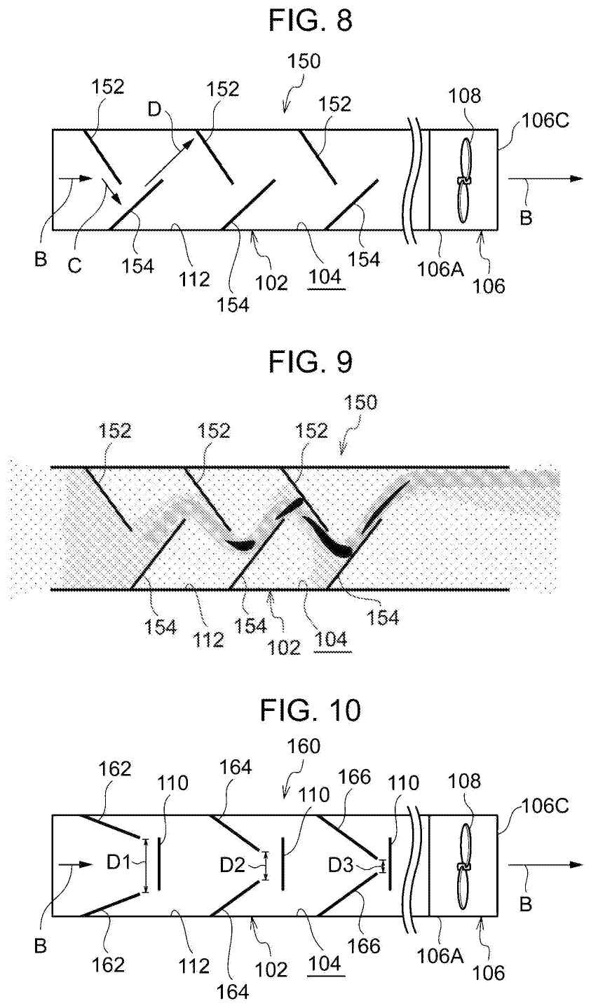

Next, a flow channel structure according to the fifth exemplary embodiment is described with reference to FIG. 8. Constituent elements identical to those in the first through fourth exemplary embodiments are given identical reference signs, and description thereof is omitted.

As illustrated in FIG. 8, in a flow channel structure 150, electrically conductive narrowing parts 152 supported by one side of an inner wall surface 112 of a duct 102 in plan view and protrude in a flow channel 104 are provided. Furthermore, in the flow channel structure 150, electrically conductive narrowing parts 154 that are supported by the other side of the inner wall surface 112 of the duct 102 in plan view and protrude in the flow channel 104 on a downstream side of the narrowing parts 152 in an air blowing direction (a direction indicated by arrows B) are provided. The narrowing parts 154 are disposed so as to cross lines extending from the respective narrowing parts 152, and an interval for passage of air is set between front ends of the narrowing parts 152 and the corresponding narrowing parts 154. In the present exemplary embodiment, a plurality of (three in the present exemplary embodiment) narrowing parts 152 and a plurality of (three in the present exemplary embodiment) narrowing parts 154 are provided along the air blowing direction in the flow channel 104.

Air hitting each of the narrowing parts 152 is blown in a direction indicated by arrow C along the narrowing part 152. Each of the narrowing parts 154 is disposed so as to be hit by air blown in the direction indicated by arrow C. Furthermore, air hitting the narrowing part 154 is blown in a direction indicated by arrow D along the narrowing part 154. A next narrowing part 152 is disposed to as to be hit by air blown in the direction indicated by arrow D. This is repeated. That is, a plurality of (three in the present exemplary embodiment) narrowing parts 152 and a plurality of (three in the present exemplary embodiment) narrowing parts 154 are disposed. The narrowing parts 152 and 154 are, for example, made of a metal.

The narrowing parts 152 and 154 are an example of a contact surface. In other words, the narrowing parts 152 and 154 serve as contact surfaces, which narrow the flow channel 104. Downstream-side angles of the narrowing parts 152 and 154 with respect to the inner wall surface 112 (angles on a downstream side in the air blowing direction of the flow channel 104) are preferably not more than 90° and not less than 10°, more preferably not more than 80° and not less than 20°, further more preferably not more than 70° and not less than 30°. In the present exemplary embodiment, the downstream-side angles of the narrowing parts 152 and 154 with respect to the inner wall surface 112 of the duct 102 are smaller than 90 degrees, for example, set to 30° to 60°.

FIG. 9 schematically illustrates a flow speed of air in the duct 102 in the flow channel structure 150. In FIG. 9, denser dots (a higher density) indicate a higher air flow speed. As illustrated in FIG. 9, a plurality of (three in the present exemplary embodiment) narrowing parts 152 and a plurality of (three in the present exemplary embodiment) narrowing parts 154 are alternately provided along the air blowing direction in the flow channel 104, and thereby a flow speed of air increases toward a downstream side in the air blowing direction of the flow channel 104. That is, the flow channel structure 150 is configured such that the narrowing parts 152 and 154 are hit by air whose flow speed increases toward a downstream side in the air blowing direction of the flow channel 104.

In the flow channel structure 150, the following effects can be obtained in addition to the effects produced by the configuration similar to the flow channel structure 100 according to the first exemplary embodiment. In the flow channel structure 150, the narrowing parts 152 and 154 serve as contact surfaces, which narrow the flow channel 104. Accordingly, the flow channel structure 150 has a simpler structure than a configuration having a member exclusive for narrowing.

In the flow channel structure 150, ultra fine particles are easier to adhere to or aggregate on the narrowing parts 152 and 154 than in a configuration in which a flow speed is uniform in an air blowing direction in a flow channel. This reduces an amount of ultra fine particles discharged to an outside of the image forming apparatus 10.

In the flow channel structure 150, ultra fine particles are easier to adhere to or aggregate on the narrowing parts 152 and 154 than in a configuration in which a downstream-side angle of a contact surface with respect to an inner wall surface of a duct is 90° or more. This reduces an amount of ultra fine particles discharged to an outside of the image forming apparatus 10.

### Sixth Exemplary Embodiment

Next, a flow channel structure according to the sixth exemplary embodiment is described with reference to FIG. 10. Constituent elements identical to those in the first through fifth exemplary embodiments are given identical reference signs, and description thereof is omitted.

As illustrated in FIG. 10, in a flow channel structure 160, a pair of narrowing parts 162 and that narrow a flow channel 104 of a duct 102 and a contact plate 110 disposed so as to be hit by air narrowed by the narrowing parts 162 are provided. Furthermore, in the flow channel structure 160, a pair of narrowing parts 164 that narrow the flow channel 104 of the duct 102 and a contact plate 110 disposed so as to be hit by air narrowed by the narrowing parts 164 are provided on a downstream side of the narrowing parts 162 and the contact plate 110. Furthermore, in the flow channel structure 160, a pair of narrowing parts 166 that narrow the flow channel 104 of the duct 102 and a contact plate 110 disposed so as to be hit by air narrowed by the narrowing parts 166 are provided on a downstream side of the narrowing parts 164 and the contact plate 110.

The narrowing parts 162, the narrowing parts 164, and the narrowing parts 166 are pairs of electrically conductive plates supported at opposing positions of an inner wall surface 112 of the duct 102 and protrude in the flow channel 104. The narrowing parts 162, the narrowing parts 164, and the narrowing parts 166 are, for example, made of a metal.

Downstream-side angle of the narrowing parts 162 with respect to the inner wall surface 112, downstream-side angle of the narrowing parts 164 with respect to the inner wall surface 112, and downstream-side angle of the narrowing parts 166 with respect to the inner wall surface 112 become larger in this order. In other words, the downstream-side angle of the narrowing parts 162 with respect to the inner wall surface 112, the downstream-side angle of the narrowing parts 164 with respect to the inner wall surface 112, and the downstream-side angle of the narrowing parts 166 with respect to the inner wall surface 112 become larger toward a downstream side in an air blowing direction (a direction indicated by arrows B).

Furthermore, a size (interval) D1 between the narrowing parts 162, a size (interval) D2 between the narrowing parts 164, and a size (interval) D3 between the narrowing parts 166 become narrower in this order. In other words, the size D2 between the narrowing parts 164 on a downstream side in the air blowing direction is narrower than the size D1 between the narrowing parts 162 on an upstream side in the air blowing direction, and the size D3 between the narrowing parts 166 on a downstream side in the air blowing direction is narrower than the size D2 of the narrowing parts 164 on an upstream side in the air blowing direction.

In the flow channel structure 160, a flow speed of air becomes higher toward a downstream side in the air blowing direction of the flow channel 104 due to the presence of the narrowing parts 162, the narrowing parts 164, and the narrowing parts 166.

In the flow channel structure 160, the following effects can be obtained in addition to the effects produced by the configuration similar to the flow channel structure 140 according to the fourth exemplary embodiment. In the flow channel structure 150, ultra fine particles are easier to adhere to or aggregate on the plurality of contact plates 110 than in a configuration in which a size (interval) between narrowing parts is uniform along an air blowing direction. This reduces an amount of ultra fine particles discharged to an outside of the image forming apparatus 10.

Although three narrowing parts and three contact plates are provided in the present exemplary embodiment, the number of narrowing parts and the number of contact plates may be changed.

### Seventh Exemplary Embodiment

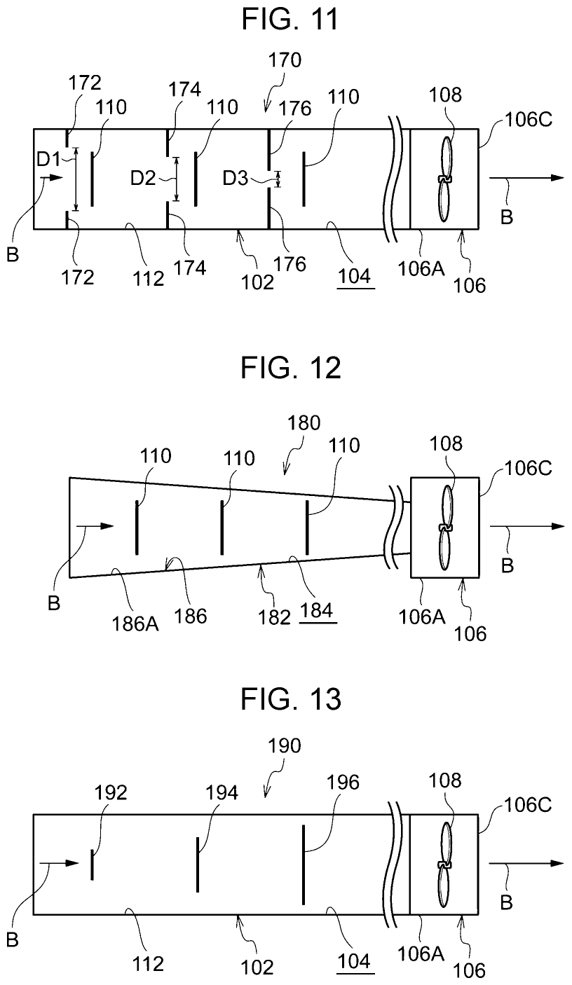

Next, a flow channel structure according to a seventh exemplary embodiment is described with reference to FIG. 11. Constituent elements identical to those in the first through sixth exemplary embodiments are given identical reference signs, and description thereof is omitted.

As illustrated in FIG. 11, in a flow channel structure 170, a pair of narrowing parts 172 that narrow a flow channel 104 of a duct 102 and a contact plate 110 disposed so as to be hit by air narrowed by the narrowing parts 172 are provided. Furthermore, in the flow channel structure 170, a pair of narrowing parts 174 that narrow the flow channel 104 of the duct 102 and a contact plate 110 disposed so as to be hit by air narrowed by the narrowing parts 174 are provided on a downstream side of the narrowing parts 172 and the contact plate 110. Furthermore, in the flow channel structure 160, a pair of narrowing parts 176 that narrow the flow channel 104 of the duct 102 and a contact plate 110 disposed so as to be hit by air narrowed by the narrowing parts 176 are provided on a downstream side of the narrowing parts 174 and the contact plate 110.

The narrowing parts 172, the narrowing parts 174, and the narrowing parts 176 are pairs of electrically conductive plates that are supported at opposing positions of an inner wall surface 112 of the duct 102 and protrude in the flow channel 104. The narrowing parts 172, the narrowing parts 174, and the narrowing parts 176 are, for example, made of a metal.

Downstream-side angles of the narrowing parts 172 with respect to the inner wall surface 112, downstream-side angles of the narrowing parts 174 with respect to the inner wall surface 112, and downstream-side angles of the narrowing parts 176 with respect to the inner wall surface 112 are equal. In the present exemplary embodiment, these angles are set to 90°.

A size (interval) D1 between the narrowing parts 172, a size (interval) D2 between the narrowing parts 174, and a size (interval) D3 between the narrowing parts 176 become smaller in this order. That is, the size (interval) D1 between the narrowing parts 172, the size (interval) D2 between the narrowing parts 174, and the size (interval) D3 between the narrowing parts 176 become narrower toward a downstream side in an air blowing direction (a direction indicated by arrows B).

In the flow channel structure 170, the following effects can be obtained in addition to the effects produced by the configuration similar to the flow channel structure 140 according to the fourth exemplary embodiment. In the flow channel structure 170, ultra fine particles are easier to adhere to or aggregate on the plurality of contact plates 110 than in a configuration in which a size (interval) between narrowing parts is uniform along an air blowing direction. This reduces an amount of ultra fine particles discharged to an outside of the image forming apparatus 10.

### Eighth Exemplary Embodiment

Next, a flow channel structure according to an eighth exemplary embodiment is described with reference to FIG. 12. Constituent elements identical to those in the first through seventh exemplary embodiments are given identical reference signs, and description thereof is omitted.

As illustrated in FIG. 12, in a flow channel structure 180, a narrowing part 186 that narrows a flow channel 184 of a duct 182 is provided. The narrowing part 186 is configured to narrow the flow channel 184 by gradually narrowing a dimension (distance) in a width direction of an inner wall 186A of the duct 182 toward a downstream side in an air blowing direction (a direction indicated by arrows B). A plurality of (three in the present exemplary embodiment) contact plates 110 having the same size are provided in the duct 182.

In the flow channel structure 180, the following effect can be obtained in addition to the effects produced by the configuration similar to the flow channel structure 140 according to the fourth exemplary embodiment. The flow channel structure 180 has a simpler structure than a configuration in which a member exclusive for narrowing is provided.

### Ninth Exemplary Embodiment

Next, a flow channel structure according to the ninth exemplary embodiment is described with reference to FIG. 13. Constituent elements identical to those in the first through eighth exemplary embodiments are given identical reference signs, and description thereof is omitted.

As illustrated in FIG. 13, in a flow channel structure 190, a plurality of (three in the present exemplary embodiment) electrically conductive contact plates 192, 194, and 196 are provided so as to cross an air blowing direction (a direction indicated by arrows B) in a duct 102. The contact plates 192, 194, and 196 become larger in size toward a downstream side in the air blowing direction (the direction indicated by arrows B). Accordingly, intervals between an inner wall surface 112 of the duct 102 and the contact plates 192, 194, and 196 become narrower toward a downstream side in the air blowing direction (the direction indicated by arrows B).

In the flow channel structure 190, the intervals between the inner wall surface 112 of the duct 102 and the contact plates 192, 194, and 196 become narrower toward a downstream side in the air blowing direction (the direction indicated by arrows B), and therefore a flow speed increases toward a downstream side in the air blowing direction.

In the flow channel structure 190, the following effect can be obtained in addition to the effects produced by the configuration similar to the flow channel structure 100 according to the first exemplary embodiment. In the flow channel structure 190, ultra fine particles are easier to adhere to or aggregate on the contact plates 192, 194, and 196 than in a configuration in which a flow speed is uniform in an air blowing direction in the flow channel. This reduces an amount of ultra fine particles discharged to an outside of the image forming apparatus 10.

### Tenth Exemplary Embodiment

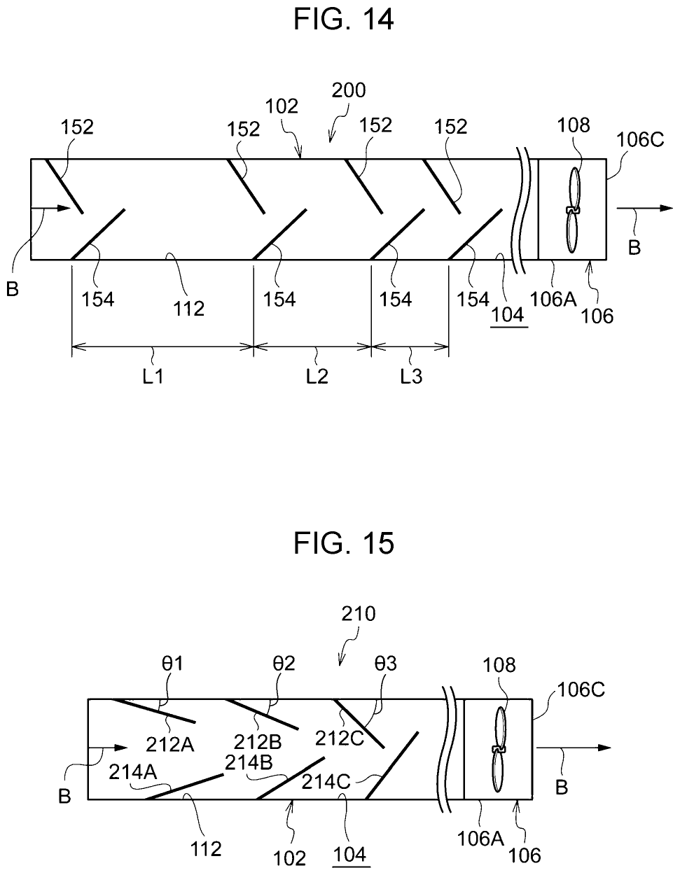

Next, a flow channel structure according to a tenth exemplary embodiment is described with reference to FIG. 14. Constituent elements identical to those in the first through ninth exemplary embodiments are given identical reference signs, and description thereof is omitted.

As illustrated in FIG. 14, in a flow channel structure 200, a plurality of (four in the present exemplary embodiment) narrowing parts 152 and a plurality of (four in the present exemplary embodiment) narrowing parts 154 are alternately provided along an air blowing direction in a flow channel 104. In plan view, the narrowing parts 152 are provided on one side of an inner wall surface 112 of the duct 102, and the narrowing parts 154 are provided on the other side of the inner wall surface 112 of the duct 102. As described earlier, the narrowing parts 152 and 154 are an example of a contact surface and serve as contact surfaces, which narrow the flow channel 104.

In the flow channel structure 200, intervals (distances) L1, L2, and L3 between base ends of the narrowing parts 154 in an air blowing direction (a direction indicated by arrows B) become narrower toward a downstream side in the air blowing direction (the direction indicated by arrows B). Similarly, intervals (distances) between base ends of the narrowing parts 152 in the air blowing direction (the direction indicated by arrows B) are also set to L1, L2, and L3 and become narrower toward a downstream side in the air blowing direction (the direction indicated by arrows B).

In the flow channel structure 200, the following effects can be obtained in addition to the effects produced by the configuration similar to the flow channel structure 150 according to the fifth exemplary embodiment. In the flow channel structure 200, ultra fine particles are easier to adhere to or aggregate on the narrowing parts 152 and 154 on a downstream side than in a configuration in which an interval (distance) between contact surfaces in an air blowing direction remains uniform toward a downstream side in the air blowing direction. This reduces an amount of ultra fine particles discharged to an outside of the image forming apparatus 10.

### Eleventh Exemplary Embodiment

A flow channel structure according to the eleventh exemplary embodiment is described with reference to FIG. 15. Constituent elements identical to those in the first through tenth exemplary embodiments are given identical reference signs, and description thereof is omitted.

As illustrated in FIG. 15, in a flow channel structure 210, a plurality of (three in the present exemplary embodiment) narrowing parts 212A, 212B, and 212C are provided in this order toward a downstream side in an air blowing direction (a direction indicated by arrows B) on one side of an inner wall surface 112 of a duct 102 in plan view. In the flow channel structure 210, a plurality of (three in the present exemplary embodiment) narrowing parts 214A, 214B, and 214C are provided in this order toward a downstream side in the air blowing direction (the direction indicated by arrows B) on the other side of the inner wall surface 112 of the duct 102 in plan view. In the flow channel structure 200, the narrowing parts 212A, 212B, and 212C on one side of the inner wall surface 112 and the narrowing parts 214A, 214B, and 214C on the other side of the inner wall surface 112 are alternately provided toward a downstream side in the air blowing direction in the flow channel 104. In other words, the narrowing part 212A, the narrowing part 214A, the narrowing part 212B, the narrowing part 214B, the narrowing part 212C, and the narrowing part 214C are provided in this order toward a downstream side in the air blowing direction in the flow channel 104. The narrowing parts 212A, 212B, and 212C and the narrowing parts 214A, 214B, and 214C are an example of a contact surface and serve as contact surfaces, which narrow the flow channel 104.

A downstream-side angle 81 of the narrowing part 212A with respect to the inner wall surface 112, a downstream-side angle 82 of the narrowing part 212B with respect to the inner wall surface 112, and a downstream-side angle 83 of the narrowing part 212C with respect to the inner wall surface 112 become larger toward a downstream side in the air blowing direction (i.e., 81<82<83). For example, the downstream-side angle 81 of the narrowing part 212A with respect to the inner wall surface 112 is preferably 10° or more, and the downstream-side angle 83 of the narrowing part 212C with respect to the inner wall surface 112 is preferably 90° or less.

Similarly, a downstream-side angle of the narrowing part 214A with respect to the inner wall surface 112, a downstream-side angle of the narrowing part 214B with respect to the inner wall surface 112, and a downstream-side angle of the narrowing part 212C with respect to the inner wall surface 112 become larger toward a downstream side in the air blowing direction.

In the flow channel structure 210, the following effect can be obtained in addition to the effects produced by the configuration similar to the flow channel structure 150 according to the fifth exemplary embodiment. In the flow channel structure 210, ultra fine particles are easier to adhere to or aggregate on the narrowing parts 212B, 212C, 214B, and 214C on a downstream side than in a configuration in which downstream-side angles of contact surfaces with respect to an inner wall surface of a duct are equal. This reduces an amount of ultra fine particles discharged to an outside of the image forming apparatus 10.

### Twelfth Exemplary Embodiment

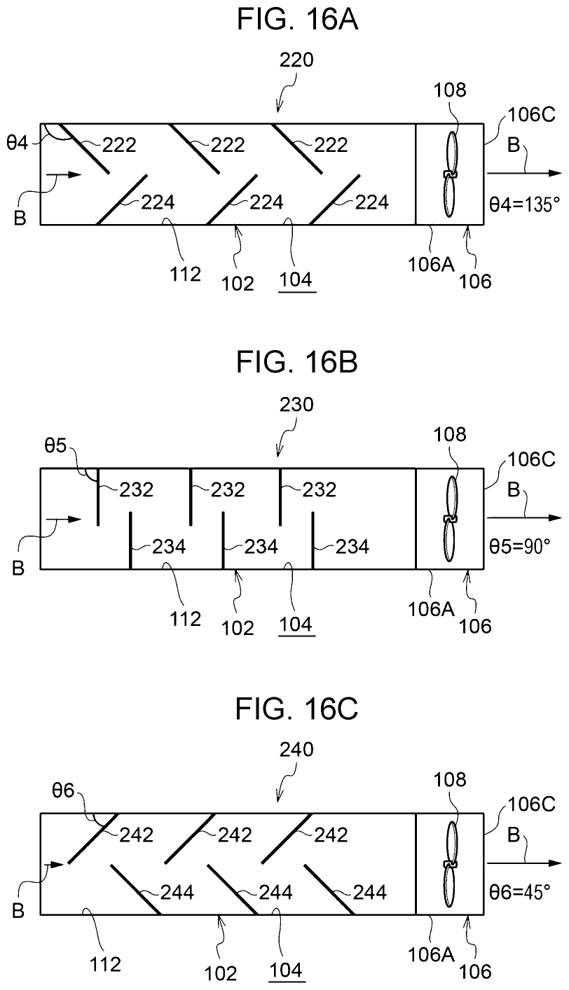

Next, a flow channel structure according to the twelfth exemplary embodiment is described with reference to FIGS. 16A through 16C. Constituent elements identical to those in the first through eleventh exemplary embodiments are given identical reference signs, and description thereof is omitted.

FIGS. 16A through 16C illustrate flow channel structures 220, 230, and 240 that are different in terms of upstream-side angles of narrowing parts with respect to an inner wall surface 112 of a duct 102. As illustrated in FIG. 16A, in the flow channel structure 220, a plurality of (three in the present exemplary embodiment) narrowing parts 222 and a plurality of (three in the present exemplary embodiment) narrowing parts 224 are alternately provided along an air blowing direction in a flow channel 104. In plan view, the narrowing parts 222 are provided on one side of the inner wall surface 112 of the duct 102, and the narrowing parts 224 are provided on the other side of the inner wall surface 112 of the duct 102. The narrowing parts 222 and 224 are an example of a contact surface. An upstream-side angle θ4 of each of the narrowing parts 222 and 224 with respect to the inner wall surface 112 of the duct 102 is set to 135°. Each of the narrowing parts 222 and the narrowing parts 224 is a sheet metal and is joined to the inner wall surface 112, for example, by welding.

As illustrated in FIG. 16B, in the flow channel structure 230, a plurality of (three in the present exemplary embodiment) narrowing parts 232 and a plurality of (three in the present exemplary embodiment) narrowing parts 234 are alternately provided along an air blowing direction in the flow channel 104. In plan view, the narrowing parts 232 are provided on one side of the inner wall surface 112 of the duct 102, and the narrowing parts 234 are provided on the other side of the inner wall surface 112 of the duct 102. The narrowing parts 232 and 234 are an example of a contact surface. An upstream-side angle 85 of each of the narrowing parts 232 and 234 with respect to the inner wall surface 112 of the duct 102 is set to 90°. Each of the narrowing parts 232 and the narrowing parts 234 is a sheet metal and is joined to the inner wall surface 112, for example, by welding.

As illustrated in FIG. 16C, in the flow channel structure 240, a plurality of (three in the present exemplary embodiment) narrowing parts 242 and a plurality of (three in the present exemplary embodiment) narrowing parts 244 are alternately provided along an air blowing direction in the flow channel 104. In plan view, the narrowing parts 242 are provided on one side of the inner wall surface 112 of the duct 102, and the narrowing parts 244 are provided on the other side of the inner wall surface 112 of the duct 102. The narrowing parts 242 and 244 are an example of a contact surface. An upstream-side angle θ6 of each of the narrowing parts 242 and 244 with respect to the inner wall surface 112 of the duct 102 is set to 45°. Each of the narrowing parts 242 and the narrowing parts 244 is a sheet metal and is joined to the inner wall surface 112, for example, by welding.

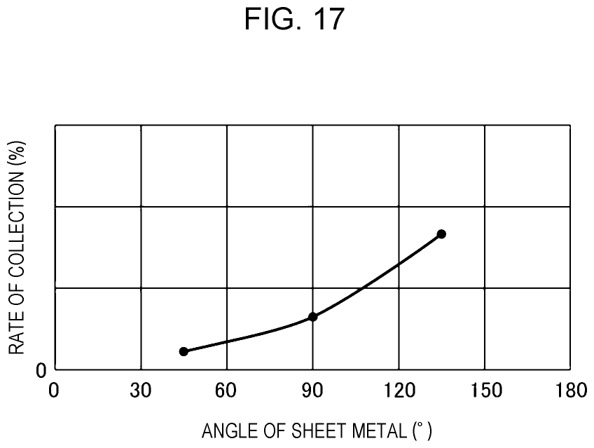

FIG. 17 illustrates a relationship between an upstream-side angle of a narrowing part (sheet metal) with respect to the inner wall surface 112 of the duct 102 and a rate of collection of ultra fine particles (UFPs) in an outlet part of the duct 102. The rate of collection is a percentage of an amount of collected ultra fine particles assuming that the whole amount of ultra fine particles is 100. As illustrated in FIG. 17, the rate of collection of ultra fine particles (UFPs) becomes larger as an upstream-side angle of a narrowing part (sheet metal) with respect to the inner wall surface 112 of the duct 102 becomes larger. In this experiment, the rate of collection of ultra fine particles (UFPs) is largest in the flow channel structure 220 in which the upstream-side angle 84 of each of the narrowing parts 222 and 224 with respect to the inner wall surface 112 of the duct 102 is 135°.

In other words, the rate of collection of ultra fine particles (UFPs) is large in a case where a downstream-side angle of a narrowing part (sheet metal) with respect to the inner wall surface 112 of the duct 102 is small. The result of this experiment shows that a downstream-side angle of a narrowing part (sheet metal) with respect to the inner wall surface 112 of the duct 102 is preferably, for example, 90° or less.

### Thirteenth Exemplary Embodiment

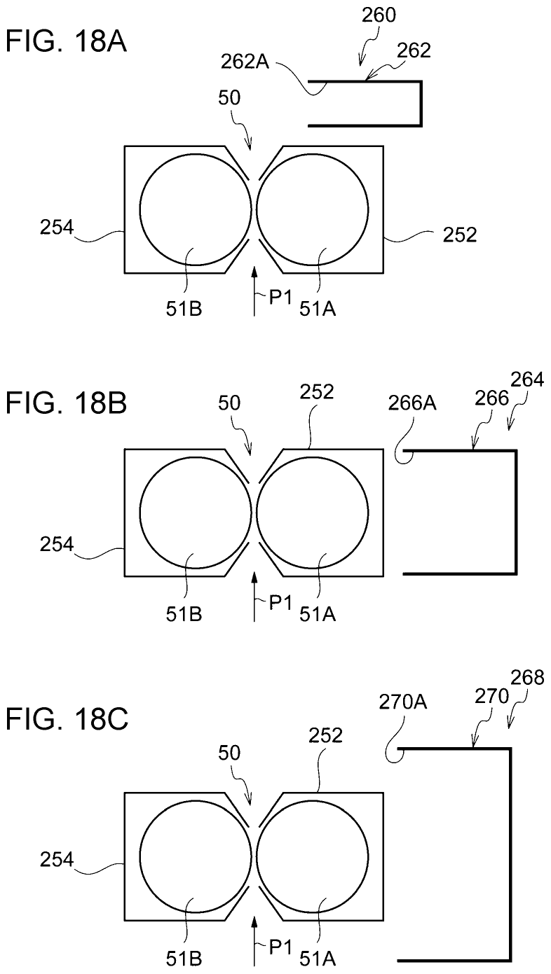

Next, a flow channel structure according to the thirteenth exemplary embodiment is described with reference to FIG. 18. Constituent elements identical to those in the first through twelfth exemplary embodiments are given identical reference signs, and description thereof is omitted.

FIGS. 18A through 18C illustrate flow channel structures 260, 264, and 268 that are different in terms of a position of an inlet of a duct that sucks air around a fixation device 50. As illustrated in FIG. 18A, the fixation device 50 includes a heating rotating body 51A, a pressing rotating body 51B, a housing 252 that covers the heating rotating body 51A excluding a side thereof that is in contact with the pressing rotating body 51B, and a housing 252 that covers the pressing rotating body 51B excluding a heating rotating body 51A side thereof. The flow channel structure 260 includes a duct 262 that sucks air around the fixation device 50 by using a fan (not illustrated). In the present exemplary embodiment, an inlet 262A of the duct 262 is provided on a downstream side of the heating rotating body 51A in a transport direction (a direction indicated by arrow P1) in which a sheet of paper P is transported.

As illustrated in FIG. 18B, the flow channel structure 264 includes a duct 266 that sucks air around the fixation device 50 by using a fan (not illustrated). In the present exemplary embodiment, an inlet 266A of the duct 266 is provided close to a central part (right beside the heating rotating body 51A) of the heating rotating body 51A in a transport direction (a direction indicated by arrow P1) in which a sheet of paper P is transported.

As illustrated in FIG. 18C, the flow channel structure 268 includes a duct 270 that sucks air around the fixation device 50 by using a fan (not illustrated). In the present exemplary embodiment, an inlet 270A of the duct 270 is provided so as to surround the heating rotating body 51A in a transport direction (a direction indicated by arrow P1) in which a sheet of paper P is transported.

A configuration of a contact plate serving as a contact surface provided in flow channels in the ducts 262, 266, and 270 is identical to the contact plate 110 of the flow channel structure 100 according to the first exemplary embodiment.

A result of measurement of rates of collection of ultra fine particles in outlet parts of the ducts 262, 266, and 270 by using the flow channel structures 260, 264, and 268 illustrated in FIGS. 18A through 18C confirms that the flow channel structure 268 illustrated in FIG. 18C has the largest rate of collection of ultra fine particles and the flow channel structure 264 illustrated in FIG. 18B has the second largest rate of collection of ultra fine particles.

Furthermore, the result confirms that the flow channel structure 268 illustrated in FIG. 18C has a larger rate of collection of ultra fine particles and the flow channel structure 264 illustrated in FIG. 18B has a similar rate of collection of ultra fine particles as compared with a case where an inlet of the duct 102 is provided on an inlet side of the fixation device 50 illustrated in FIG. 3.

Although specific exemplary embodiments of the present disclosure have been described in detail, the present disclosure is not limited to these exemplary embodiments, and it is apparent for a person skilled in the art that other various exemplary embodiments are possible within the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A flow channel structure comprising:
a duct that includes a flow channel through which air is blown and sucks air around a fixation device that fixes a toner image on a recording medium by using an air blowing unit; and
an electrically conductive contact surface that is provided in the duct and is disposed so as to cross an air blowing direction in the duct.

2. The flow channel structure according to claim 1, wherein
the duct includes a narrowing part that narrows the flow channel; and
the contact surface is provided so as to be hit by air narrowed by the narrowing part.

3. The flow channel structure according to claim 2, wherein
the narrowing part narrows the flow channel while also serving as the contact surface.

4. The flow channel structure according to claim 2, wherein
the narrowing part narrows the flow channel while also serving as an inner wall of the duct.

5. The flow channel structure according to claim 1, wherein
the contact surface is hit by air whose flow speed increases toward a downstream side in the air blowing direction of the flow channel.

6. The flow channel structure according to claim 2, wherein
the contact surface is hit by air whose flow speed increases toward a downstream side in the air blowing direction of the flow channel.

7. The flow channel structure according to claim 5, wherein
the narrowing part includes a plurality of narrowing parts;
the contact surface includes a plurality of contact surfaces; and
the contact surfaces are disposed on a downstream side, in the air blowing direction, of the respective narrowing parts that narrow the flow channel.

8. The flow channel structure according to claim 6, wherein
the narrowing part includes a plurality of narrowing parts;
the contact surface includes a plurality of contact surfaces; and
the contact surfaces are disposed on a downstream side, in the air blowing direction, of the respective narrowing parts that narrow the flow channel.

9. The flow channel structure according to claim 7, wherein
one of the narrowing parts on a downstream side in the air blowing direction narrows the flow channel more than another one of the narrowing parts on an upstream side in the air blowing direction.

10. The flow channel structure according to claim 8, wherein
one of the narrowing parts on a downstream side in the air blowing direction narrows the flow channel more than another one of the narrowing parts on an upstream side in the air blowing direction.

11. The flow channel structure according to claim 5, wherein
the contact surface includes a plurality of contact surfaces; and
an interval between adjacent two of the contact surfaces becomes narrower toward a downstream side in the air blowing direction.

12. The flow channel structure according to claim 6, wherein
the contact surface includes a plurality of contact surfaces; and
an interval between adjacent two of the contact surfaces becomes narrower toward a downstream side in the air blowing direction.

13. The flow channel structure according to claim 5, wherein
the contact surface includes a plurality of contact surfaces; and
downstream-side angles of the contact surfaces with respect to an inner wall surface of the duct become larger toward a downstream side in the air blowing direction.

14. The flow channel structure according to claim 6, wherein
the contact surface includes a plurality of contact surfaces; and
downstream-side angles of the contact surfaces with respect to an inner wall surface of the duct become larger toward a downstream side in the air blowing direction.

15. The flow channel structure according to claim 1, wherein
the contact surface includes a plurality of contact surfaces; and
downstream-side angles of the contact surfaces with respect to an inner wall surface of the duct are smaller than 90 degrees.

16. The flow channel structure according to claim 1, wherein
an inner wall surface of the duct is an electrically conductive member.

17. The flow channel structure according to claim 1, wherein
the duct includes an inlet, an outlet, and a wall connecting the inlet and the outlet; and
the inlet is provided at a position including an upstream side of the fixation device in a transport direction in which the recording medium is transported.

18. An image forming apparatus comprising:
an image forming part that forms a toner image and transfers the toner image onto the recording medium;
a fixation device that fixes the toner image transferred onto the recording medium; and
the flow channel structure according to claim 1 into which air around the fixation device flows.
